(19) United States
(12) Patent Application Publication
(10) Pub. No.: US 2021/0232645 A1
(43) Pub. Date: Jul. 29, 2021

(54) IMAGE FORMING APPARATUS AND SCREEN RENDERING METHOD

(71) Applicant: KYOCERA DOCUMENT SOLUTIONS INC., Osaka (JP)

(72) Inventor: HIDEYUKI SASAKI, OSAKA (JP)

(21) Appl. No.: 17/155,155

(22) Filed: Jan. 22, 2021

(30) Foreign Application Priority Data
Jan. 24, 2020 (JP) 2020-009711

(51) Int. Cl. G06F 16/958; G06F 16/955; G06F 16/9538; G06F 3/14

(52) U.S. Cl. CPC G06F 16/958; G06F 3/1407; G06F 16/9538; G06F 16/955

(57) ABSTRACT

An image forming apparatus includes: a first web server and a first web browser; and a communication interface communicably connected to an information processing apparatus configured to operate as a second web server and a second web browser, the second web browser including a script including a URL and a command; the first web server being configured to receive the script from the information processing apparatus, store the script in the memory, and transmit an event to the first web browser, the event indicating that the script is stored, the first web browser being configured to receive the event from the first web server, acquire the script from the memory, execute the script to thereby access the URL in the second web server, the URL being included in the script, and receive the screen data from the second web server, and render the received screen data.

### CROSS-REFERENCE TO RELATED PATENT APPLICATION

This application claims the benefit of Japanese Priority Patent Application JP 2020-009711 filed Jan. 24 2020, the entire contents of which are incorporated herein by reference.

### FIELD OF THE DISCLOSURE

The present disclosure relates to an image forming apparatus communicably connected to an information processing apparatus, and a screen rendering method executable by the image forming apparatus communicating with the information processing apparatus.

### BACKGROUND OF THE DISCLOSURE

An image forming apparatus which operates as a web server and a web browser and executes a web application is known. An engineer uses an information processing apparatus (typically personal computer) to develop a web application for such an image forming apparatus. Before releasing a web application, by using an information processing apparatus for developing the web application or an image forming apparatus, the engineer confirms the operation of the web application (e.g., whether the screen is displayed appropriately as intended by the engineer).

### SUMMARY OF THE DISCLOSURE

It is desirable to confirm the operation of a web application more appropriately and reliably before releasing the web application.

According to an embodiment of the present disclosure, there is provided an image forming apparatus, including:

a controller circuitry configured to operate as a first web server and a first web browser communicable with the first web server;

a display device;

a communication interface communicably connected to an information processing apparatus, the information processing apparatus being configured to operate as a second web server and a second web browser communicable with the second web server, the second web browser including a script, the script including a URL and a command, the URL indicating a position of screen data in the second web server, the command requesting to access the URL and acquire and display the screen data; and

a memory,

the first web server being configured to
receive the script from the information processing apparatus via the communication interface,
store the script in the memory, and
transmit an event to the first web browser, the event indicating that the script is stored,

the first web browser being configured to
receive the event from the first web server,
acquire the script from the memory,
execute the script to thereby access the URL in the second web server, the URL being included in the script, and receive the screen data from the second web server via the communication interface, and
render the received screen data and display the screen data on the display device.

According to an embodiment of the present disclosure, there is provided an image forming apparatus, including:

a controller circuitry configured to operate as a first web server and a first web browser communicable with the first web server;

a display device;

a communication interface communicably connected to an information processing apparatus, the information processing apparatus being configured to operate as a second web server and a second web browser communicable with the second web server, the second web browser including a script, the script including a URL and a command, the URL indicating a position of screen data including a child frame in the second web server, the command requesting to access the URL and acquire and display the screen data; and

a memory,

the first web server being configured to
receive the script from the information processing apparatus via the communication interface,
store the script in the memory, and

the first web browser being configured to
query the first web server whether or not the script is newly stored by polling,
when the first web browser receives a response indicating that the script is newly stored from the first web server,
execute the script to thereby access the URL in the second web server, the URL being included in the script, and receive the screen data including the child frame from the second web server via the communication interface, and
render the screen data including the child frame and display the screen data on the display device.

According to an embodiment of the present disclosure, there is provided a screen rendering method executable by a controller circuitry of an image forming apparatus, the image forming apparatus including

the controller circuitry configured to operate as a first web server and a first web browser communicable with the first web server,

a display device,

a communication interface communicably connected to an information processing apparatus, the information processing apparatus being configured to operate as a second web server and a second web browser communicable with the second web server, the second web browser including a script, the script including a URL and a command, the URL indicating a position of screen data in the second web server, the command requesting to access the URL and acquire and display the screen data, and

a memory,

the screen rendering method including:

by the first web server,
receiving the script from the information processing apparatus via the communication interface;
storing the script in the memory; and
transmitting an event to the first web browser, the event indicating that the script is stored; and

by the first web browser,
receiving the event from the first web server;
acquiring the script from the memory;
executing the script to thereby access the URL in the second web server, the URL being included in the script, and receiving the screen data from the second web server via the communication interface; and
rendering the received screen data and displaying the screen data on the display device.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows a screen rendering system according to a first embodiment of the present;

FIG. 2 shows a hardware configuration of an image forming apparatus;

FIG. 3 shows a hardware configuration of an information processing apparatus;

FIG. 4 shows a functional configuration of the screen rendering system of the first embodiment;

FIG. 5 shows an operational flow of the second web browser of the information processing apparatus;

FIG. 6 shows an operational flow the first web server of the image forming apparatus when the first web server receives an event;

FIG. 7 shows an operational flow of the script acquisition unit of the first web browser of the image forming apparatus;

FIG. 8 shows an operational flow of the script execution unit of the first web browser of the image forming apparatus;

FIG. 9 shows an operational flow of a second web server of the information processing apparatus;

FIG. 10 shows an operational flow of the first web server of the image forming apparatus when the first web server receives polling;

FIG. 11 shows a functional configuration of a screen rendering system according to the second embodiment;

FIG. 12 shows an operational flow of the script acquisition unit of the first web browser of the image forming apparatus;

FIG. 13 shows a functional configuration of a screen rendering system according to the third embodiment;

FIG. 14 shows an operational flow the first web server of the image forming apparatus; and

FIG. 15 shows an operational flow of the script execution unit of the first web browser of the image forming apparatus.

### DETAILED DESCRIPTION OF THE EXEMPLARY EMBODIMENTS

Hereinafter, embodiments of the present disclosure will be described with reference to the drawings.

### I. First embodiment

### 1. Screen Rendering System

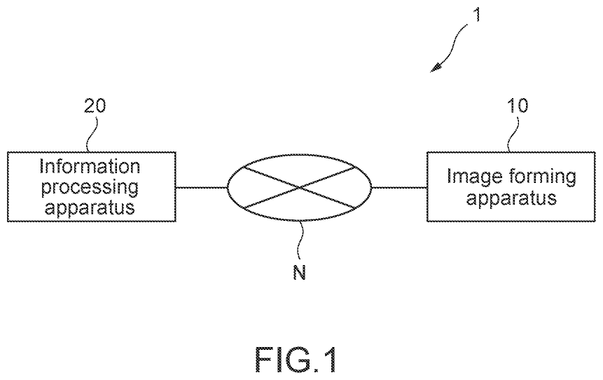

FIG. 1 shows a screen rendering system according to a first embodiment of the present.

The screen rendering system 1 includes an image forming apparatus 10 and an information processing apparatus 20. The image forming apparatus 10 and the information processing apparatus 20 are connected to each other through a network N such as a LAN (Local Area Network) by using a network communication interface so as to allow HTTP communication.

The image forming apparatus 10 is typically an MFP (Multifunction Peripheral). The image forming apparatus 10 operates as a web server and a web browser. Web applications are installed and executed on the image forming apparatus 10 at the time of shipment or after shipment. The image forming apparatus 10 is a so-called test machine for checking the operation of such a web application, for example, whether or not a screen is appropriately displayed as intended by an engineer.

The information processing apparatus 20 is typically a personal computer. A user of the information processing apparatus 20 is typically an engineer who develops a web application. The engineer is developing a web application for the image forming apparatus 10 by using the information processing apparatus 20.

One of the development processes of a web application for an image forming apparatus is the creation of a screen to be displayed on a display device of the image forming apparatus. Web application screens are described in HTML. During the development of web applications (prior to release), the screen described in HTML should be displayed on the display device to ensure that it is displayed appropriately as intended by the engineer.

There are two ways to display the screen for confirmation. The first method is a method in which an information processing apparatus used for developing a web application is operated as a web server and a web browser, and a web browser of the information processing apparatus displays a screen on a display device (display) of the information processing apparatus. The second method is a method in which a web application is installed from an information processing apparatus to an image forming apparatus, the image forming apparatus is operated as a web server and a web browser, and the web browser of the image forming apparatus displays a screen on a display device (touch panel) of the image forming apparatus.

In the first method, the web browser of the information processing apparatus that is developing the web application displays the web application, so it does not take time and effort to install the web application on another apparatus. However, since the web browser of the information processing apparatus is different from the web browser of the image forming apparatus, the screen displayed by the web browser of the information processing apparatus may not be the same as the screen displayed by the web browser of the image forming apparatus. In other words, the screen displayed by the web browsers of the image forming apparatus may not be reproduced, and is only a simulated simulation and lacks accuracy.

In the second method, since the web browser of the image forming apparatus displays the screen, there is no lack of accuracy. However, it is necessary to install the web application from the information processing apparatus to the image forming apparatus remotely or by wire, and to activate the web application by the image forming apparatus, which takes time and labor. During the development of a web application, a confirmation window may be displayed, for example, whenever one line or character of HTML is added or changed, or the screen design is changed by one pixel. As a result, even in a small web application, it is necessary to display a screen several hundred times. Therefore, installing, starting, and executing a web application each time takes a lot of time and effort. In order to suppress labor and time, for example, it is conceivable that the web browser of the image forming apparatus displays the screen only at the delimitation of the development process or at the final stage of development. However, in this case, if an error is found at that time, a similar error may be embedded in HTML of several windows, which may result in a large return.

In view of the above circumstances, in the embodiments of the present disclosure, it is desirable to, while guaranteeing the accuracy by displaying the screen by the web browser of the image forming apparatus, eliminate the labor and time required for installing the web application from the information processing apparatus to the image forming apparatus.

### 2. Hardware Configuration of Image Forming Apparatus

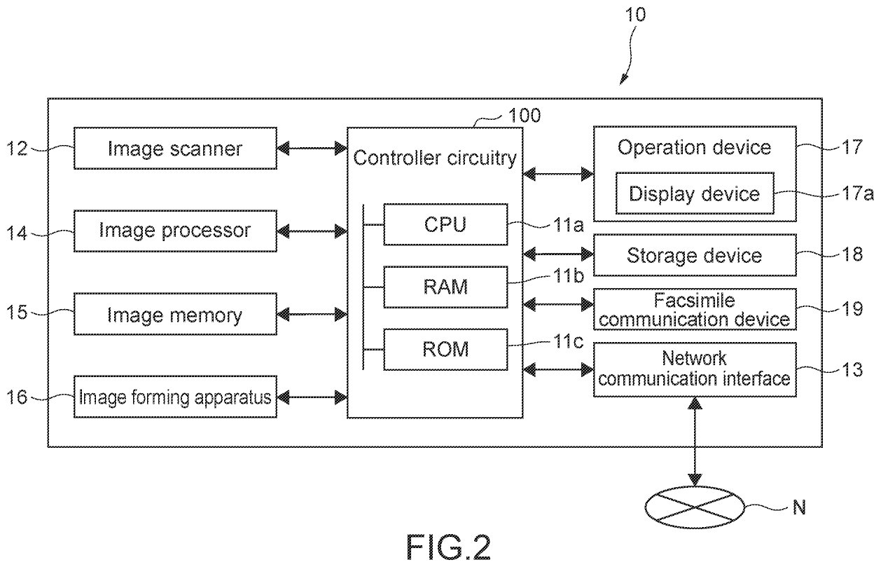

FIG. 2 shows a hardware configuration of an image forming apparatus.

An image forming apparatus 10 includes the controller circuitry 100. The controller circuitry 100 includes the CPU (Central Processing Unit) 11a, the RAM (Random Access Memory) 11b, the ROM (Read Only Memory) 11c, dedicated hardware circuitries, and the like and performs overall operational control of the image forming apparatus 10. The CPU 11a loads information processing programs stored in the ROM 11c in the RAM 11b and executes the information processing programs. The ROM 11c is a nonvolatile memory that stores programs executable by the CPU 11a, data, and the like. The ROM 11c is an example of a non-transitory computer readable recording medium.

The controller circuitry 100 is connected to the image scanner 12, the image processor 14 (including GPU (Graphics Processing Unit)), the image memory 15, the image forming apparatus 16 (printer), the operation device 17 including the display device 17a (touch panel), the large volume nonvolatile storage device 18 such as an HDD (Hard Disk Drive) or an SSD (Solid State Drive), the facsimile communication device 19, the network communication interface 13, and the like. The controller circuitry 100 performs operational control of the respective devices connected thereto and transmits/receives signals and data to/from those devices. The operation device 17 (touch panel) is one mode of an input device. A sound input device including a microphone may be provided as an input device. The network communication interface 13 is an interface connected to the information processing apparatus 20 for HTTP communication.

### 3. Hardware Configuration of Information Processing Apparatus

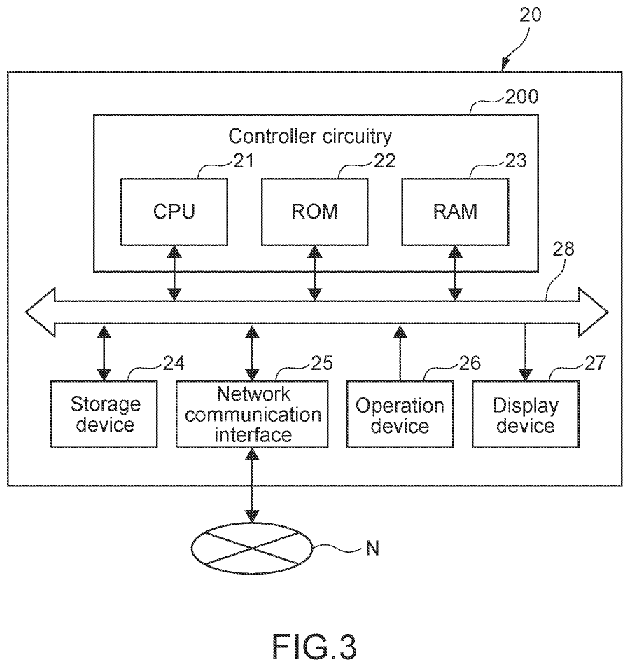

FIG. 3 shows a hardware configuration of an information processing apparatus.

The information processing apparatus 20 includes the CPU 21, the ROM 22, the RAM 23, the storage device 24, which is a large-volume nonvolatile memory such as an HDD or an SSD, the network communication interface 25, the operation device 26, and the display device 27, and the bus 28 connecting them to each other.

The controller circuitry 200 includes the CPU 21, the ROM 22, and the RAM 23. The CPU 21 loads information processing programs stored in the ROM 22 in the RAM 23 and executes the information processing programs. The ROM 22 stores programs executable by the CPU 21, data, and the like nonvolatile. The ROM 22 is an example of a non-transitory computer readable recording medium. The network communication interface 25 is an interface connected to the image forming apparatus 10 for HTTP communication.

### 4. Functional Configuration of Screen Rendering System

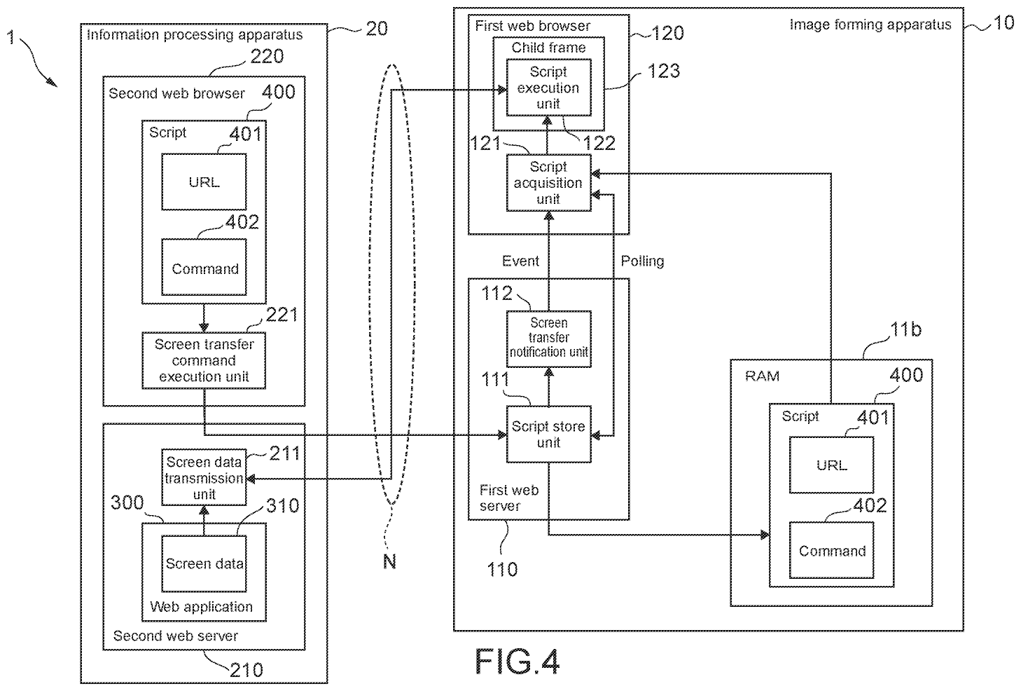

FIG. 4 shows a functional configuration of the screen rendering system of the first embodiment.

The controller circuitry 100 of the image forming apparatus 10 operates as a first web server 110 and a first web browser 120. The first web server 110 and the first web browser 120 may communicate with each other.

The first web server 110 operates as a script store unit 111 and a screen transfer notification unit 112.

The first web browser 120 operates as a script acquisition unit 121 and a script execution unit 122.

The controller circuitry 200 of the information processing apparatus 20 operates as a second web server 210 and a second web browser 220. The second web server 210 and the second web browser 220 may communicate with each other.

The second web server 210 includes a screen data transmission unit 211. In addition, the second web server 210 includes a web application 300.

The web application 300 is a web application being developed by an engineer using the information processing apparatus 20. The web application 300 includes screen data 310 (HTML data). The web application 300 operates the first web browser 120 of the image forming apparatus 10 to display the screen data 310 on the display device 17a (touch panel) of the image forming apparatus 10.

The second web browser 220 includes a screen transfer command execution unit 221. In addition, the second web browser 220 includes a script 400. The second web browser 220 is described in HTML or JavaScript.

The script 400 includes the URL 401 and the command 402. The URL 401 is a parameter used to execute the command 402 to indicate the position in the second web server 210 of the screen data 310 having a child frame (inline frame). The command 402 is an HTTP request for accessing the URL 401 to acquire the screen data 310 and for displaying the screen data 310 having the child frame (inline frame) (for changing the screen display).

### 5. Operation Flow of the Screen Rendering System

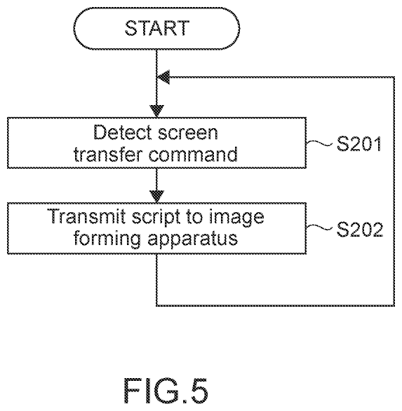

FIG. 5 shows an operational flow of the second web browser of the information processing apparatus.

The screen transfer command execution unit 221 of the second web browser 220 of the information processing apparatus 20 detects an operation input from the engineer to the operation device 26 (Step S201). Then, the screen transfer command execution unit 221 transmits the script 400 to the first web server 110 of the image forming apparatus 10 through the network N through the second web server 210 (Step S202).

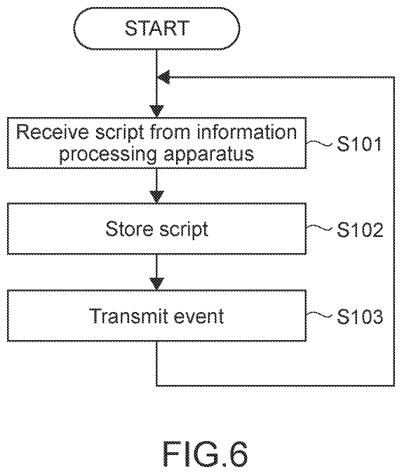

FIG. 6 shows an operational flow the first web server of the image forming apparatus when the first web server receives an event.

The script store unit 111 of the first web server 110 of the image forming apparatus 10 receives the script 400 from the information processing apparatus 20 through the network N (Step S101). Then, the script store unit 111 stores the received script 400 in the RAM 11b (or in the nonvolatile storage device 18. The same applies to the below) (Step S102).

The screen transfer notification unit 112 of the first web server 110 of the image forming apparatus 10 transmits an event indicating that the script 400 is stored to the first web browser 120 of the image forming apparatus 10 (Step S103). The event is, for example, a virtual key press event (not an HTTP communication) indicating that a special virtual key (i.e., key not present in the operation device 17) is pressed.

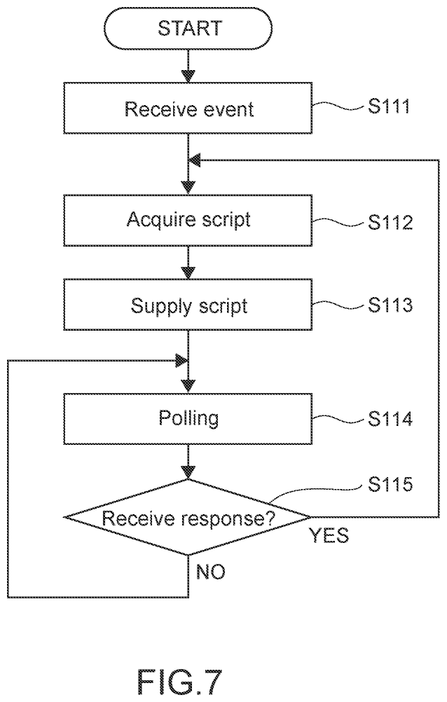

FIG. 7 shows an operational flow of the script acquisition unit of the first web browser of the image forming apparatus.

The script acquisition unit 121 of the first web browser 120 of the image forming apparatus 10 receives the event from the first web server 110 (Step S111). Then, the script acquisition unit 121 acquires the script 400 from the RAM 11b (Step S112) and supplies the script 400 to the script execution unit 122 (Step S113).

As described above, the script 400 includes the URL 401 and the command 402. The URL 401 indicates the position in the second web server 210 of the screen data 310 having the child frame, i.e., the inline frame. The command 402 is an HTTP request for accessing the URL 401 to acquire the screen data 310 and for displaying the screen data 310 having the child frame (inline frame) (for changing the screen display).

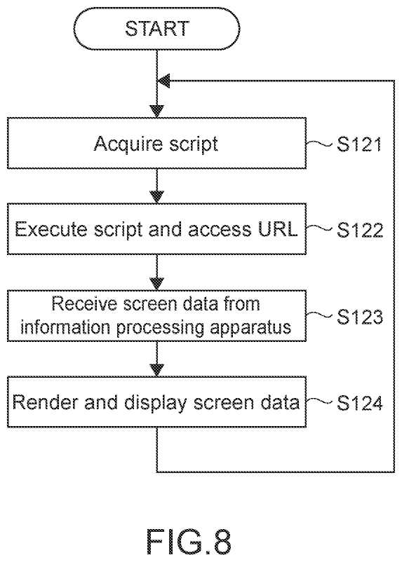

FIG. 8 shows an operational flow of the script execution unit of the first web browser of the image forming apparatus.

The script execution unit 122 of the first web browser 120 of the image forming apparatus 10 acquires the script 400 from the script acquisition unit 121 (Step S121). The script execution unit 122 executes the acquired script 400. Specifically, the script execution unit 122 accesses the URL 401 through the network N according to the command 402 included in the script 400 (Step S122). In other words, the script execution unit 122 transmits an HTTP request (GET or POST) for acquiring the screen data 310 (HTML data) having the child frame described in the URL 401 to the second web server 210 of the information processing apparatus 20 via the network N.

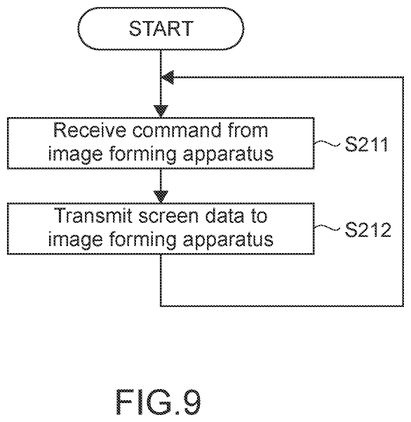

FIG. 9 shows an operational flow of a second web server of the information processing apparatus.

The screen data transmission unit 211 of the second web server 210 of the information processing apparatus 20 receives the command 402 from the first web browser 120 of the image forming apparatus 10 via the network N (Step S211). The screen data transmission unit 211 transmits the screen data 310 (HTML data) having the child frame described in the URL 401 to the first web browser 120 of the image forming apparatus 10 through the network N (Step S212).

The script execution unit 122 of the first web browser 120 of the image forming apparatus 10 receives the screen data 310 having the child frame from the second web server 210 of the information processing apparatus 20 via the network N (Step S123). The script execution unit 122 renders the received screen data 310 having the child frame 123 and displays the screen data 310 on the display device 17a (touch panel) (Step S124).

By the way, each time the script 400 is received (Step S101) and stored (Step S102), the first web server 110 of the image forming apparatus 10 transmits the event to the first web browser 120 (Step S103) (Loop). However, after the script execution unit 122 of the first web browser 120 renders and displays the screen data 310 having the child frame 123 (Step S124), the script execution unit 122 (child frame 123) of the first web browser 120 receives the event. As a result, the script acquisition unit 121 may not acquire the newly stored script 400, and as a result, the script execution unit 122 (child frame 123) may not execute the new script 400.

In view of the above circumstances, when the script execution unit 122 of the first web browser 120 of the image forming apparatus 10 displays the child frame 123 (Step S124), the script acquisition unit 121 starts polling the first web server 110 (Step S114). Specifically, the script acquisition unit 121 periodically queries the first web server 110 whether or not the script 400 is newly received and stored (polling).

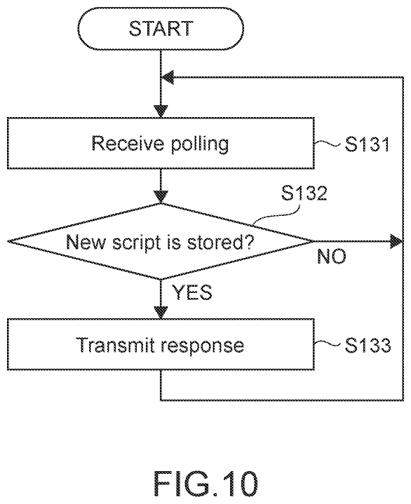

FIG. 10 shows an operational flow of the first web server of the image forming apparatus when the first web server receives polling.

The first web server 110 of the image forming apparatus 10 receives an inquiry (polling) from the first web browser 120 (Step S131). Then, the script store unit 111 of the first web server 110 newly determines whether the script 400 is received from the second web browser 220 of the information processing apparatus 20 (Step S101) and stored in the RAM 11b (Step S102) (Step S132). When it is determined that the script 400 is newly received and stored (Step S132, YES), the script store unit 111 transmits a response indicating that the script 400 is newly received and stored to the first web browser 120 (Step S133).

The script acquisition unit 121 of the first web browser 120 of the image forming apparatus 10 receives a response (Step S133) indicating that the script 400 is newly received and stored from the first web browser 120 (Step S115, YES). Then, the script acquisition unit 121 acquires the script 400 from the RAM 11b (Step S112) and supplies the script 400 to the script execution unit 122 (Step S113).

By the way, the second web browser 220 of the information processing apparatus 20 may receive the screen data 310 from the second web server 210, render the received screen data 310, and render the screen data 310 on the display device 27 of the information processing apparatus 20.

### II. Second Embodiment

In the second and third embodiments, the same or similar structures and operations as those of the first embodiment are denoted by the same or similar reference symbols, and description and illustration thereof are omitted, and description will be focused on different structures and operations. In particular, since the operation of the information processing apparatus 20 according to the second and third embodiments is the same as the operation of the information processing apparatus 20 according to the first embodiment, the operation of the image forming apparatus 10 will be mainly described.

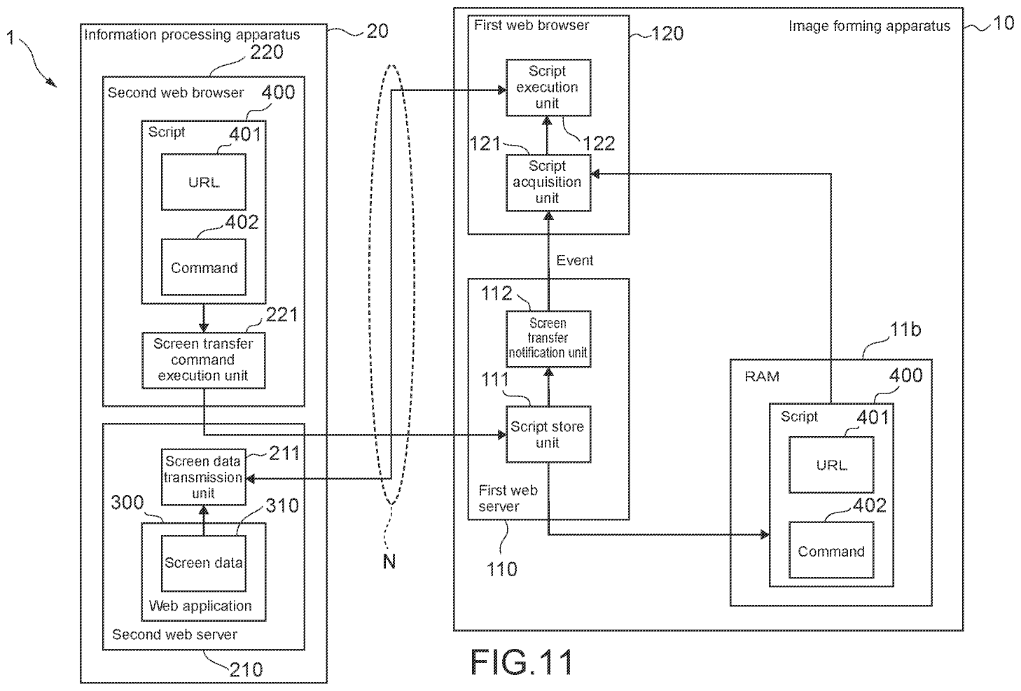

FIG. 11 shows a functional configuration of a screen rendering system according to the second embodiment.

In the second embodiment, the first web browser 120 of the image forming apparatus 10 does not poll the first web server 110. However, since the first web server 110 of the image forming apparatus 10 transmits an event to the first web browser 120 each time the script 400 is newly stored, there is no problem without polling. With this mechanism, the first web browser 120 always acquires the script 400 triggered by the receipt of an event. This mechanism (always triggered by the reception of events and no polling) is feasible when the screen data 310 does not include a child frame (inline frame).

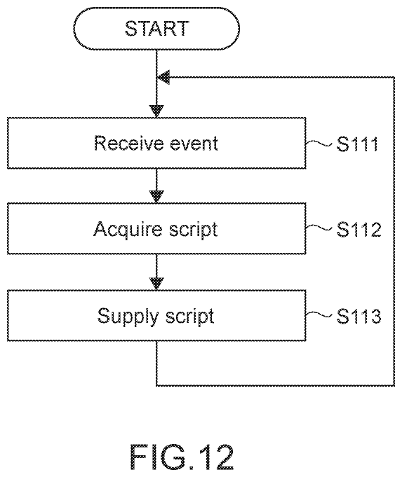

FIG. 12 shows an operational flow of the script acquisition unit of the first web browser of the image forming apparatus.

The script acquisition unit 121 of the first web browser 120 of the image forming apparatus 10 receives the event (Step S103) from the first web server 110 (Step S111). Then, the script acquisition unit 121 acquires the script 400 from the RAM 11b (Step S112) and supplies the script 400 to the script execution unit 122 (Step S113). The script execution unit 122 executes the script 400 (Step S121 to Step S124) (FIG. 8).

### III. Third Embodiment

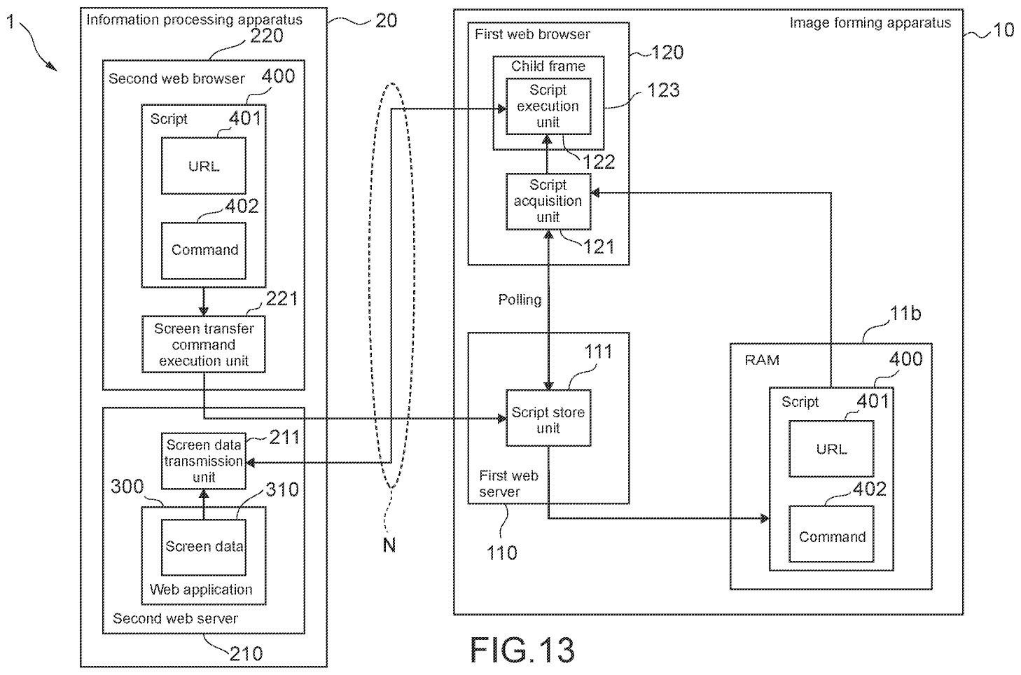

FIG. 13 shows a functional configuration of a screen rendering system according to the third embodiment.

In the third embodiment, the first web server 110 of the image forming apparatus 10 does not transmit an event to the first web browser 120. In contrast, the first web browser 120 of the image forming apparatus 10 always polls the first web server 110. With this mechanism, the first web browser 120 always acquires the script 400 triggered by a response to polling. This mechanism (transmit no event and always poll) is feasible when a child frame (inline frame) is displayed from the beginning.

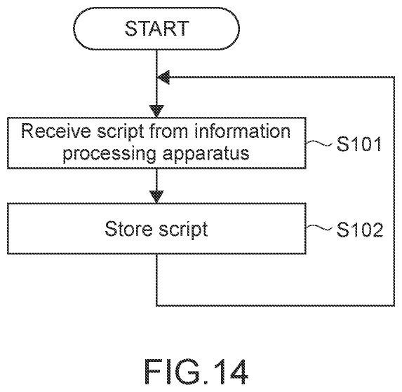

FIG. 14 shows an operational flow the first web server of the image forming apparatus.

The script store unit 111 of the first web server 110 of the image forming apparatus 10 receives the script 400 from the second web browser 220 of the information processing apparatus 20 through the network N (Step S101). Then, the script store unit 111 stores the received script 400 in the RAM 11b (Step S102). The first web server 110 transmits no event.

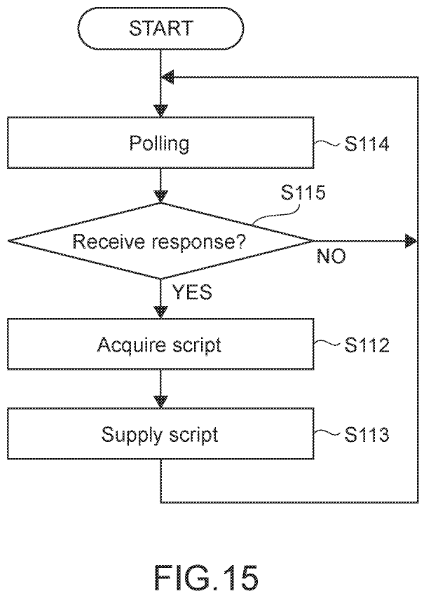

FIG. 15 shows an operational flow of the script execution unit of the first web browser of the image forming apparatus.

The script acquisition unit 121 of the image forming apparatus 10 starts polling the first web server 110 (Step S114). Specifically, the script acquisition unit 121 periodically queries the first web server 110 whether or not the script 400 is newly received and stored (polling). The first web server 110 transmits a response to polling (Step S131 to Step S133) (FIG. 10).

The script acquisition unit 121 of the first web browser 120 of the image forming apparatus 10 receives a response (Step S133) indicating that the script 400 is newly received and stored from the first web browser 120 (Step S115, YES). Then, the script acquisition unit 121 acquires the script 400 from the RAM 11b (Step S112) and supplies the script 400 to the script execution unit 122 (Step S113). The script execution unit 122 executes the script 400 (Step S121 to Step S124) (FIG. 8).

### IV. Conclusion

(1) According to the first and second embodiments, the first web server 110 of the image forming apparatus 10 receives the script 400 from the second web browser 220 of the information processing apparatus 20, and transmits an event indicating that the script 400 is stored to the first web browser 120. The first web browser 120 of the image forming apparatus 10 receives the event from the first web server 110 and executes the script 400 to access the URL 401 in the second web server 210 included in the script 400, receives the screen data 310 from the second web server 210, and displays the screen data on the display device 17a (touch panel) of the image forming apparatus 10.

Thus, it does not take time and effort to install the web application on the image forming apparatus 10 from the information processing apparatus 20 which is developing the web application. At the same time, since the first web browser 120 of the image forming apparatus 10 displays the screen, there is no lack of accuracy. This allows for a more appropriate and reliable confirmation of the operation of the web application prior to releasing the web application. In addition, since the first web browser 120 of the image forming apparatus 10 acquires the script 400 with the reception of the event as a trigger (in other words, does not acquire the script 400 unless the event is received), the load on the controller circuitry 100 of the image forming apparatus 10 is small.

(2) According to the first embodiment, the first web browser 120 of the image forming apparatus 10 accesses the URL 401 in the second web server 210 included in the script 400 by executing the script 400, receives the screen data 310 having the child frame 123 from the second web server 210, renders the screen data 310 having the child frame 123, and displays the screen data on the display device 17a (touch panel) of the image forming apparatus 10.

Thus, the first web browser 120 of the image forming apparatus 10 may acquire the script 400 firstly using the reception of the event as a trigger, and thereafter using a method other than the reception of the event as a trigger.

(3) According to the first embodiment, after creating the child frame 123, the first web browser 120 of the image forming apparatus 10 periodically inquires of the first web server 110 whether or not the script 400 is stored by polling.

Thus, the first web browser 120 of the image forming apparatus 10 may acquire the script 400 firstly using the reception of the event as a trigger and, after displaying the child frame 123, using the response to the polling as a trigger. In other words, the first web browser 120 of the image forming apparatus 10 starts polling after displaying the child frame 123. Thus, the first web browser 120 polls only when the first web server 110 of the image forming apparatus 10 stores the script 400 (in short, only when the engineer wants to display the screen data 310), so the load on the controller circuitry 100 of the image forming apparatus 10 is smaller than the load in the case where the first web browser 120 always polls (before displaying the child frame 123). Further, after the first web browser 120 displays the child frame 123, due to the constraint of the cross domain, the child frame 123 will receive an event. As a result, the script acquisition unit 121 may not acquire the newly stored script 400, and as a result, the child frame 123 may not execute the new script 400. Despite this situation, after displaying the child frame 123, the script acquisition unit 121 is capable of acquiring a newly stored script 400 triggered by the response to the polling.

(4) According to the third embodiment, the first web browser 120 of the image forming apparatus 10 periodically inquires of the first web server 110 whether or not the script 400 is stored by polling.

Thus, despite the situation in which the child frame 123 will receive an event due to cross-domain constraints, so that the script acquisition unit 121 may not acquire the newly stored script 400, and as a result, the child frame 123 may not execute the new script 400, the first web browser 120 may acquire the newly stored script 400 by using polling.

(5) According to the first, second, and third embodiments, the second web browser 220 of the information processing apparatus 20 may also receive the screen data 310 from the second web server 210 of the information processing apparatus 20, and render the received screen data 310 on the display device 27 of the information processing apparatus 20.

As described above, the second web browser 220 of the information processing apparatus 20 may display the screen data 310 as in the conventional case, and the first web browser 120 of the image forming apparatus 10 may display the screen data 310. Thus, it does not take time and effort to install the web application on the image forming apparatus 10 from the information processing apparatus 20 which is developing the web application. At the same time, since the first web browser 120 of the image forming apparatus 10 displays the screen, there is no lack of accuracy.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus, comprising:
a controller circuitry configured to operate as a first web server and a first web browser communicable with the first web server;
a display device;
a communication interface communicably connected to an information processing apparatus, the information processing apparatus being configured to operate as a second web server and a second web browser communicable with the second web server, the second web browser including a script, the script including a URL and a command, the URL indicating a position of screen data in the second web server, the command requesting to access the URL and acquire and display the screen data; and
a memory,
the first web server being configured to
receive the script from the information processing apparatus via the communication interface,
store the script in the memory, and
transmit an event to the first web browser, the event indicating that the script is stored,
the first web browser being configured to
receive the event from the first web server,
acquire the script from the memory,
execute the script to thereby access the URL in the second web server, the URL being included in the script, and receive the screen data from the second web server via the communication interface, and
render the received screen data and display the screen data on the display device.

2. The image forming apparatus according to claim 1, wherein
the URL included in the script indicates a position of screen data including a child frame, and
the first web browser is configured to
execute the script to thereby receive the screen data including the child frame from the second web server via the communication interface, and
render the screen data including the child frame and display the screen data on the display device.

3. The image forming apparatus according to claim 2, wherein
the first web browser is configured to
periodically query the first web server whether or not the script is newly stored by polling, and
when the first web browser receives a response indicating that the script is newly stored from the first web server, execute the script.

4. The image forming apparatus according to claim 1, wherein
the second web browser of the information processing apparatus is configured to
receive the screen data from the second web server, and
render the received screen data and display the screen data on a display device of the information processing apparatus.

5. An image forming apparatus, comprising:
a controller circuitry configured to operate as a first web server and a first web browser communicable with the first web server;
a display device;
a communication interface communicably connected to an information processing apparatus, the information processing apparatus being configured to operate as a second web server and a second web browser communicable with the second web server, the second web browser including a script, the script including a URL and a command, the URL indicating a position of screen data including a child frame in the second web server, the command requesting to access the URL and acquire and display the screen data; and
a memory,
the first web server being configured to
receive the script from the information processing apparatus via the communication interface,
store the script in the memory, and
the first web browser being configured to
query the first web server whether or not the script is newly stored by polling,
when the first web browser receives a response indicating that the script is newly stored from the first web server,
execute the script to thereby access the URL in the second web server, the URL being included in the script, and receive the screen data including the child frame from the second web server via the communication interface, and
render the screen data including the child frame and display the screen data on the display device.

6. The image forming apparatus according to claim 5, wherein
the second web browser of the information processing apparatus is configured to
receive the screen data from the second web server, and
render the received screen data and display the screen data on a display device of the information processing apparatus.

7. A screen rendering method executable by a controller circuitry of an image forming apparatus, the image forming apparatus including
the controller circuitry configured to operate as a first web server and a first web browser communicable with the first web server,
a display device,
a communication interface communicably connected to an information processing apparatus, the information processing apparatus being configured to operate as a second web server and a second web browser communicable with the second web server, the second web browser including a script, the script including a URL and a command, the URL indicating a position of screen data in the second web server, the command requesting to access the URL and acquire and display the screen data, and
a memory,
the screen rendering method comprising:
by the first web server,
receiving the script from the information processing apparatus via the communication interface;
storing the script in the memory; and
transmitting an event to the first web browser, the event indicating that the script is stored; and
by the first web browser,
receiving the event from the first web server;
acquiring the script from the memory;
executing the script to thereby access the URL in the second web server, the URL being included in the script, and receiving the screen data from the second web server via the communication interface; and
rendering the received screen data and displaying the screen data on the display device.
